(19) United States
(12) Patent Application Publication
(10) Pub. No.: US 2013/0100044 A1
(43) Pub. Date: Apr. 25, 2013

(54) Method for Detecting Wake Conditions of a Portable Electronic Device

(71) Applicants: Hong Zhao, Naperville, IL (US); Hung D. Pham, Crystal Lake, IL (US)

(72) Inventors: Hong Zhao, Naperville, IL (US); Hung D. Pham, Crystal Lake, IL (US)

(73) Assignee: Motorola Mobility, Inc., Libertyville, IL (US)

(21) Appl. No.: 13/279,735

(22) Filed: Oct. 24, 2011

(51) Int. Cl. G06F 3/041

(52) U.S. Cl. 345/173

(57) ABSTRACT

There is described a portable electronic device capable of detecting wake conditions comprising a motion sensor, a touch sensor and a processor. The motion sensor is configured to detect tap data associated with user input within a predetermined time period. The touch sensor is configured to detect touch data associated with the user input within the predetermined time period. The touch sensor is activated in response to detecting the tap data at the motion sensor. The processor is configured to determine whether the touch data corresponds to at least one touch criterion, and activate a function of the portable electronic device in response to determining that the touch data corresponds to the at least one touch criterion.

### CROSS REFERENCE TO RELATED APPLICATIONS

The present application is related to co-pending and commonly assigned U.S. application Ser. No. 12/970,763, filed on Dec. 16, 2010, from which benefits under 35 USC 120 are hereby claimed and the contents of which are incorporated herein by reference.

### FIELD OF THE INVENTION

The present disclosure relates generally to an electronic device and more particularly to a method and apparatus for wake conditions of the electronic device when detecting a tap by the sensors of the device.

### BACKGROUND OF THE INVENTION

Electronic devices, including mobile phones and other portable devices, are increasingly being upgraded with improvised applications and functionalities. For example, a mobile phone may include a touch-sensitive screen that enables one to interact directly with what is displayed, rather than indirectly with a cursor controlled by a mouse or a touchpad. The touch-sensitive screen can sense fingers, hands, and passive devices such as stylus. Thus, the touch-sensitive screen can be used to activate a function of the electronic device.

In the present systems, activating a function of the electronic devices by a tap using an accelerometer has been proposed for many mobile phones. However, in existing conventional systems using only a tap, extensive studies in feature prototype have shown that it is extremely difficult to achieve desirable operation in certain cases.

### BRIEF DESCRIPTION OF THE DRAWINGS

FIG. 1 is a perspective view of an embodiment of a portable electronic device in accordance with the present invention.

FIG. 2 is a block diagram representing example internal components of a portable electronic device in accordance with the present invention.

FIG. 3 is a flow diagram representing an example operation of a portable electronic device in accordance with the present invention.

### DETAILED DESCRIPTION OF THE EMBODIMENTS

There is described a portable electronic device capable of, and method for, detecting wake and/or unlock conditions. The function of waking-up a display is slightly delayed subsequent to receiving a tap or multi-tap interrupt from a motion sensor of the device, such as an accelerometer. The accelerometer activates the touch sensor upon detection a tap or multi-tap. The device collects and analyzes the touch data trailing the tap or multi-tap event. The device distinguishes error or non-user input conditions from normal or user input conditions based on the analyses of the touch data trailing the tap or multi-tap. For example, a particular gesture at the touch sensor, subsequent to one or more taps detected by the motion sensor, may wake and unlock the device.

It is to be understood that any reference to a tap, tap interrupt, tap event, tap input, tap data, and the like, shall be interpreted to include a single tap as well as multiple taps (i.e., more than one tap in succession).

An aspect of the present invention is a portable electronic device capable of detecting wake conditions comprising a motion sensor, a touch sensor and a processor. The motion sensor is configured to detect tap data associated with user input within a predetermined time period. The touch sensor is configured to detect touch data associated with the user input within the predetermined time period. The touch sensor is activated in response to detecting the tap data at the motion sensor. The processor is configured to determine whether the touch data corresponds to at least one touch criterion, and activate a function of the portable electronic device in response to determining that the touch data corresponds to the at least one touch criterion.

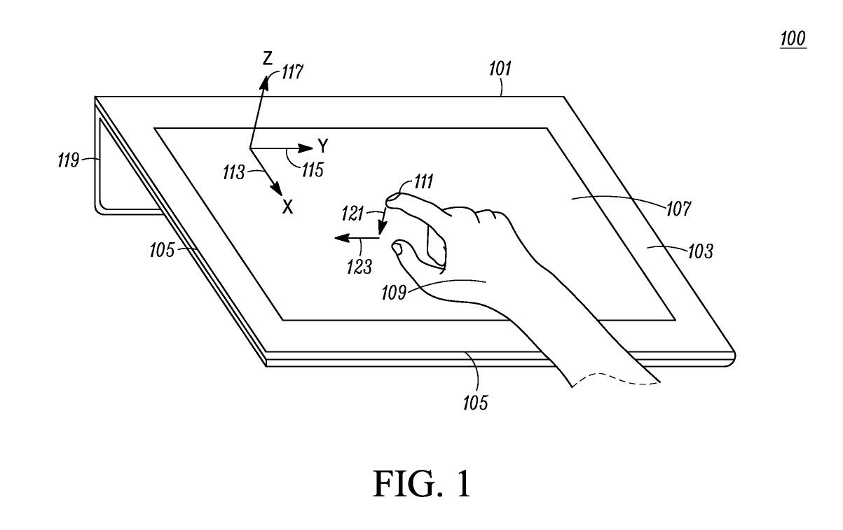

Referring to FIG. 1, there is provide a perspective view of an embodiment 100 of a portable electronic device 101 in accordance with the present invention. The portable electronic device 101 may be any type of device having an output component and one or more sensors to detect a tap or multi-tap (i.e., more than one tap) input by a user to wake up the output component. Examples of a portable electronic device 101 include, but are not limited to, a computing device, tablet device, handheld device, productivity device, media player, media reader, communication device (wireless or wired), scanner, network browser, e-commerce device, measuring device, and the like. The portable electronic device 101 may have one of a variety of different form factors including, but not limited to, a tablet, candy bar, flip/clamshell, slider, qwerty slider, rotator, and the like. For the embodiment shown in FIG. 1, the device 101 has a front surface 103 and a plurality of side surfaces 105 substantially angled from the front surface.

The portable electronic device 101 includes at least one output component and at least one input component. For one embodiment, like the one shown in FIG. 1, the device 101 includes a touch screen 107 which functions as both an output component and an input component. For example, the touch screen 107 may include a display (such as an LCD, OLED, LED, and the like) having a touch sensor (capacitive, resistive, temperature, and the like) overlaying at least a portion of the display. The front surface of the touch screen 107 may be exposed at, substantially parallel to the front surface 103 of the device 101. A user of the portable electronic device 101 may interact with the touch screen 107 by making contact with the front surface of the touch screen by the user's body part 109 and/or an object (not shown) controlled by the user. As shown in FIG. 1, the user may contact the touch screen 107 with the user's finger or other digit 111, but the user may contact the touch screen using a stylus, controller, glove, or similar object.

One or more sensors of the portable electronic device 101 may detect movement of the device in one, two, three, or more directions. For example, as represented in FIG. 1, sensors may detect movement in an x-direction 113 and a y-direction 115 of the device 101, which are both parallel to the front surface 103 of the device and the touch screen 107. The x-direction 113 and the y-direction 115 are also orthogonal to each other. The sensors may also detect movement in a z-direction 117 of the device 101, which is orthogonal to the x-direction 113 and the y-direction 115 as well as the front surface 103 of the device and the touch screen 107. Although a user may contact the touch screen 107 at many different angles, it is the z-direction 117 which represents the substantial direction of user input to the touch screen by the user. It is to be understood that any reference herein to contact with input component in a z-direction 117 or orthogonal to the surface of the input component includes any varying angle relative to the z-direction and orthogonal directions which may be utilized by a user to contact, such as a tap, the input component. However, the present invention applies to both directional and non-directional taps.

The embodiment 100 of FIG. 1 further includes an accessory 119 to support the portable electronic device 101. The accessory 119 is not a necessary part of the portable electronic device 101, but it may provide physical and/or functional enhancements to the device. For example, the accessory 119 may be a stand to maintain the portable electronic device 101 at a certain position to facilitate user input at the input component of the portable electronic device. Also, the accessory 119 may include some type of link, such as wired, wireless, electrical, magnetic, optical, acoustic, and the like, to provide or control one or more functions of the portable electronic device 101. For this example, the link may enhance the functionality of the portable electronic device, such as the function of data input, detecting false conditions or managing the wake/sleep state of the device.

The portable electronic device 101 may detect one or more taps 121 at an outer surface of its housing followed by contact 123 at its touch sensor. For some embodiments, the tap or taps 121 must occur at a surface of the touch sensor, whereas the tap or taps may occur at another surface of the housing other than the touch sensor for other embodiments. The tap or taps 121 and the subsequent contact 123 must occur within a predetermined time period. For example, the predetermined time period may be a short period to time, such as one second or less. The contact 123 at the touch sensor may includes, but are not limited to, a continuous contact at a fixed location of the touch sensor exceeding a threshold time period, a linear swipe having a substantially linear form in its entirety, and a non-linear gesture having one or more parts non-linear from at least one other part of the gesture. More than one type of contact may correspond to activation of a particular function, and two or more types of contact may correspond to activation of different functions.

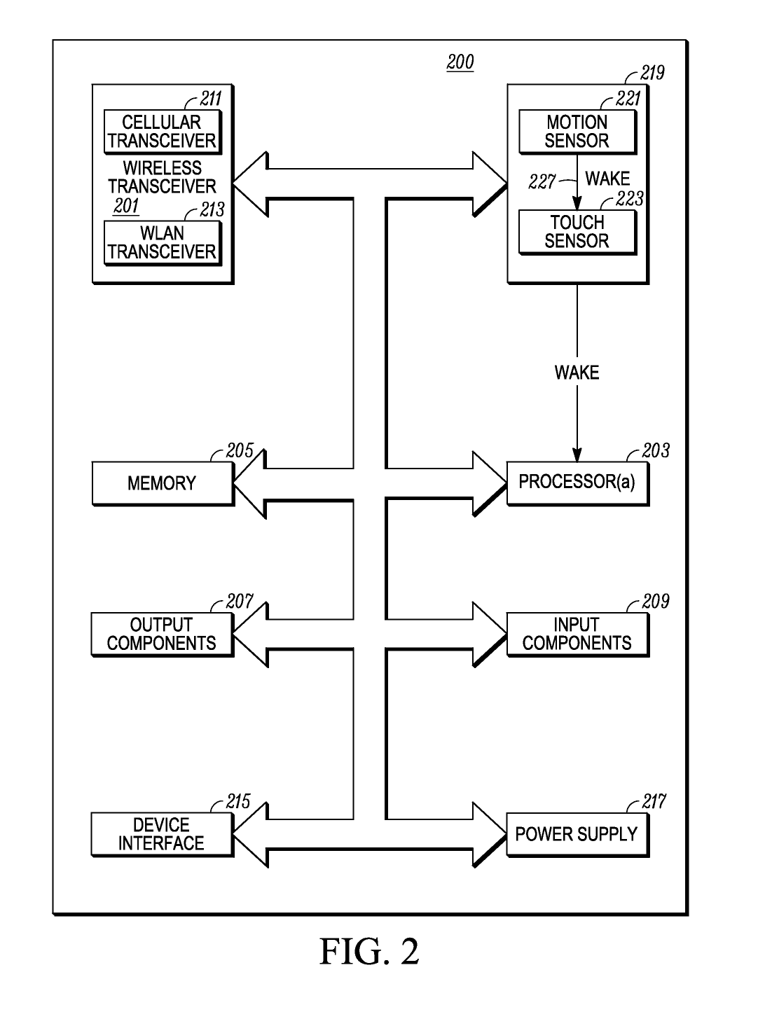

Referring to FIG. 2, there is shown a block diagram representing example components 200 that may be used for an embodiment in accordance with the present invention. The example embodiment may include one or more wireless transceivers 201, one or more processors 203, one or more memories 205, one or more output components 207, and one or more input components 209. Each embodiment may include a user interface that comprises one or more output components 207 and/or one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 311. Each wireless transceiver 201 may also utilize wireless technology for communication, such as, but are not limited to, peer-to-peer or ad hoc communications such as HomeRF, Bluetooth and IEEE 802.11 (a, b, g or n), wireless HDMI; wireless USB, and other forms of wireless communication such as infrared technology, as represented by WLAN transceiver 213. Also, each transceiver 201 may be a receiver, a transmitter or both.

The processor 203 may generate commands based on information received from one or more input components 209. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device 101, such as interaction among the components of the internal components 200, communication with external devices via each transceiver 201 and/or the device interface (see below), and storage and retrieval of applications and data to and from the memory 205. Each application includes executable code utilizing an operating system to provide more specific functionality for the portable electronic device. Data is non-executable code or information that may be referenced and/or manipulated by an operating system or application for performing functions of the portable electronic device 101.

The input components 209, such as the touch sensitive surface of the touch screen 107, or other components of the user interface, may produce an input signal in response to a user input. In addition, the input components 209 may include one or more additional components, such as a video input component such as an optical sensor (for example, a camera), an audio input component such as a microphone, and a mechanical input component or activator such as button or key selection sensors, touch pad sensor, another touch-sensitive sensor, capacitive sensor, motion sensor, and switch. Likewise, the output components 207 of the internal components 200 may include one or more video, audio and/or mechanical outputs. For example, the output components 207 may include the visible display of the touch screen 107. Other output components 207 may include a video output component such as a cathode ray tube, liquid crystal display, plasma display, incandescent light, fluorescent light, front or rear projection display, and light emitting diode indicator. Other examples of output components 207 include an audio output component such as a speaker, alarm and/or buzzer, and/or a mechanical output component such as vibrating or motion-based mechanisms.

The internal components 200 may further include a device interface 215 to provide a direct connection to auxiliary components or accessories for additional or enhanced functionality. In addition, the internal components 200 preferably include a power source 217, such as a portable battery, for providing power to the other internal components and allow portability of the portable electronic device 100.

Although the input components 209 include one or more sensors, a separate representation of the sensor circuit is shown in FIG. 2 for illustrative purposes. The portable electronic device 101 comprises a sensor circuit 219 configured to detect tap data and touch data following the tap data within a predetermined time period. The sensor circuit 219 may also determine whether the touch data corresponds to one or more criteria associated with non-user input. It is to be understood that other components of example components 200, such as the processor 203, may awaken by the sensor circuit 219 upon detection of a tap followed by touch data that corresponds to one or more criteria associated with user input. For one embodiment, the sensor circuit 219 includes a motion sensor 221 to detect the motion data and a touch sensor 223 to determine whether the motion data is followed by touch data that corresponds to the one or more criteria. For another embodiment, the sensor circuit 219 may include an interrupt line connected to the processor 203 and may wake up the device upon detection of a tap followed by touch data. For yet another embodiment, the touch sensor may include a micro-controller that can be used to determine a user defined criterion (for example, a swipe gesture) within a predetermined period after the detection of a tap. The motion sensor 221 and the touch sensor 223 may use various communication means to communicate with each other. For another embodiment, the motion sensor 221 and the touch sensor 223 may include a multi-master serial single-ended bus, such as an Inter-Integrated Circuit or two-wire interface 225, for communication with each other. For yet another embodiment, the motion sensor 221 and the touch sensor 223 may include an asynchronous signal, such as an interrupt line 227, to indicate the need for attention or a synchronous event indicating a need for a change in process execution. For example, the interrupt line 227 may be used to communicate a tap interrupt from the motion sensor 221 to the touch sensor 223 when the portable electronic device 101 is in a sleep state. The tap interrupt may indicate a possible situation where a tap by the user, or some other detected motion, is detected by the input component.

It is to be understood that FIG. 2 is provided for illustrative purposes only and for illustrating components of a portable electronic device 101 in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

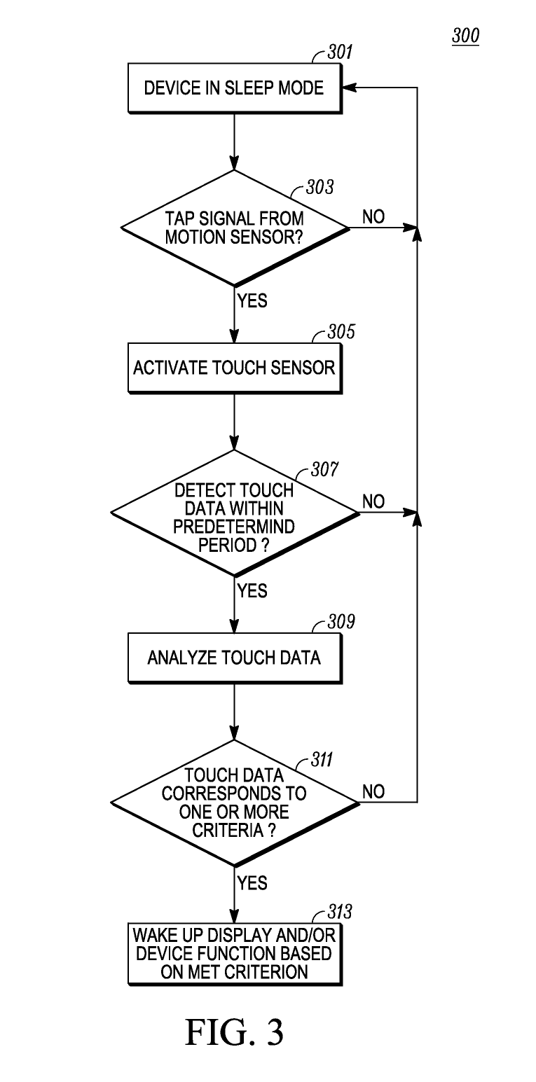

Referring to FIG. 3, there is provided a flow diagram representing an example operation 300 of the portable electronic device 101. It is to be understood that operation 300 may be performed by a sensor circuit, a motion sensor, a sensor hub, touch circuit, touch sensor, and/or a processor of the portable electronic device 101. Initially, at step 301, the operation 300 determines that the display 207 (and perhaps other components) of the portable electronic device 101 is in some type of sleep state. A sleep state is herein defined as an inactive or non-user-interactive mode of the display 207 in which power usage is lower than an active or user-interactive mode of the display. Next, for the operation 300, a motion sensor detects tap data, or an interrupt signal corresponding to a tap user input, associated with user input at step 303. As noted above, any reference to a tap and the like shall be interpreted to include a single tap as well as multiple taps, i.e., more than one tap in succession, such as a double tap. For example, a double tap is two consecutive, instantaneous points of mechanical impact at the display screen or housing by a user within a particular period of time. Next, the operation 300 activates the touch sensor in response to detecting the tap data at the motion sensor; at step 305.

The operation 300 then determines whether a touch sensor, of the input components 207, detects touch data associated with the user input subsequent to the tap user input within a predetermined time period, at step 307. As stated above, the touch data need to be detected within a predetermined time period, as represented by step 307. For the preferred embodiments, the predetermined time period is measured in terms of seconds or a fraction of a second, and is no greater than a few seconds. For some embodiments, the predetermined time period is one second or less. If the tap data is not detected, the touch data is not detected, or the detection of these data are not within the predetermined time period, then the operation 300 does not proceed to subsequent steps of the process.

The operation 300 may analyze the touch data against one or more touch criteria at step 309. For example, a processor 203 may determine whether the touch data correspond to at least one touch criterion stored at the memory 205 of the portable electronic device. This analysis may occur at any time after the detection of the tap data associated with user input by the motion sensor.

Regardless of whether the tap data is analyzed, the operation 300 determines whether the touch data corresponds to at least one touch criterion, at steps 311 and 313. For one embodiment, the user may touch-and-hold a finger or object against the touch surface of a display after a tap at the same. The touch criterion or criteria may include a continuous contact at a fixed location of the touch sensor exceeding a threshold time period. For another embodiment, the user may swipe a finger or object across the touch surface of a display after a tap at the same. The touch criterion or criteria may include a linear swipe, in which the linear swipe has a substantially linear form in its entirety. For yet another embodiment, the user may perform a non-linear gesture at the touch surface of a display after a tap at the same. The touch criterion or criteria includes a non-linear gesture, in which the non-linear gesture having at least one part that is non-linear from at least one other part of the gesture.

In step 311, a user of the portable electronic device may have more than one type of touch data to provide and is not restricted to just one type of touch data. A function may correspond to multiple different criteria, or multiple functions may be activated depending upon the type of touch data provided. For one embodiment, the user may provide first touch data corresponding to a first function of the portable electronic device and a second touch data corresponding to a second function. The function or functions activated at the portable electronic device would depend on the type of touch data provided by the user. For example, a first gesture at the touch sensor may unlock a home screen at the display of the device and a second gesture at the touch screen may present a screen related to voice calls at the display of the device. Other screens or functions, such as notifications, settings, messaging, browsing, media, connectivity, social networking, productivity, imaging, and the like, may be presented at the display dependent on the gesture provided by the user at the touch sensor. Thus, the user may select the screen or function of interest by providing the corresponding gesture at the touch screen subsequent to providing one or more taps to be sensed by the motion sensor.

In response to analyzing the touch data at step 311, the operation 300 may perform the function corresponding to the at least one touch criterion, at step 313. For example, the function of the portable electronic device may include waking the display from a sleep state to a wake state in response to determining that the touch data corresponds to one or more criteria. For other examples, the function of the portable electronic device may include one or more other functions of the device, as described above with regard to step 311. If, on the other hand, the analysis results may not be associated with one or more predetermined criteria associated with a user input condition, then the operation 300 may ignore the detected user input associated with the touch data and return to step 301. The display may be maintained at the sleep state in response to determining that the touch data subsequent to the motion data does not correspond to one or more touch criteria, and the operation 300 may wait to detect a more tap data and subsequent touch data.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of a portable electronic device for detecting wake conditions, the portable electronic device including a motion sensor and a touch sensor, the method comprising:
detecting, at the motion sensor, tap data associated with user input within a predetermined time period;
activating the touch sensor in response to detecting the tap data at the motion sensor;
detecting, at the touch sensor, touch data associated with the user input within the predetermined time period;
determining whether the touch data corresponds to at least one touch criterion; and
activating a function of the portable electronic device in response to determining that the touch data corresponds to the at least one touch criterion.

2. The method of claim 1, wherein detecting touch data associated with the user input within the predetermined time period includes detecting the touch data at the touch sensor subsequent to detecting the tap data at the motion sensor within the predetermined time period.

3. The method of claim 1, wherein determining whether the touch data corresponds to at least one touch criterion includes determining, at a processor, whether the touch data corresponds to the at least one touch criterion stored at a memory of the portable electronic device.

4. The method of claim 1, further comprising determining, at a processor, whether the tap data correspond to at least one tap criterion stored at the memory of the portable electronic device.

5. The method of claim 1, wherein the at least one touch criterion is a continuous contact at a fixed location of the touch sensor exceeding a threshold time period.

6. The method of claim 1, wherein the at least one touch criterion is a linear swipe, the linear swipe having a substantially linear form in its entirety.

7. The method of claim 1, wherein the at least one touch criterion is a non-linear gesture, the non-linear gesture having at least one part that is non-linear from at least one other part of the gesture.

8. The method of claim 1, wherein activating a function of the portable electronic device includes waking a display from a sleep state.

9. A portable electronic device capable of detecting wake conditions comprising:
a motion sensor configured to detect tap data associated with user input within a predetermined time period;
a touch sensor configured to detect touch data associated with the user input within the predetermined time period;
a processor configured to determine whether the touch data corresponds to at least one touch criterion, and activate a function of the portable electronic device in response to determining that the touch data corresponds to the at least one touch criterion.

10. The method of claim 9, the touch sensor detects the touch data subsequent to the motion sensor detecting the tap data within the predetermined time period.

11. The method of claim 9, further comprising a memory of the portable electronic device configured to store the at least one touch criterion.

12. The method of claim 9, further comprising a memory of the portable electronic device configured to store at least one tap criterion, wherein the processor determines whether the tap data correspond to the at least one tap criterion.

13. The method of claim 9, wherein the at least one touch criterion is a continuous contact at a fixed location of the touch sensor exceeding a threshold time period.

14. The method of claim 9, wherein the at least one touch criterion is a linear swipe, the linear swipe having a substantially linear form in its entirety.

15. The method of claim 9, wherein the at least one touch criterion is a non-linear gesture, the non-linear gesture having at least one part that is non-linear from at least one other part of the gesture.

16. The method of claim 9, further comprising a display, wherein the function of the portable electronic device includes waking the display from a sleep state.
